(19) United States
(12) Patent Application Publication
(10) Pub. No.: US 2002/0095653 A1
(43) Pub. Date: Jul. 18, 2002

(54) Visual architecture software language

(76) Inventors: Shawn Parr, Northbridge (AU); Geoff Dromey, Indooroopilly (AU)

Correspondence Address: David P. Dureska, Buckingham, Doolittle & Burroughs, LLP, 4518 Fulton Drive, NW, Canton, OH, 44735-5548, US

(21) Appl. No.: 09/963,069

(22) Filed: Sep. 25, 2001

(30) Foreign Application Priority Data
Mar. 30, 1999 (AU) PP9495

(51) Int. Cl. G06F 9/44; G06F 9/45

(52) U.S. Cl. 717/105; 717/107; 717/140

(57) ABSTRACT

A visual architecture software language is described comprising reusable components and programmable channels. The reusable components define discrete software modules in any language. The programmable channels define data flow and control flow between components. A visual representation of functional computer software is generated in a visual environment by integrating the components and channels. A compiling means converts the visual representation into executable code in the form of executable instructions and data tables. The visual architecture software language may also include an integration server that executes the executable code.

A system incorporating the language and a method of programming with the language is also disclosed.

The invention relates to a visual architecture software language (VASL) that facilitates component based design and implementation of complex software systems. In particular, the invention provides a hidden-code system for developing complex programs from components and channels.

### BACKGROUND TO THE INVENTION

Large software systems are currently represented textually in code, large numbers of modules arranged sequentially one after the other, page after page or screen after screen. For example, the software that runs the Boeing 777 aircraft consists of 4 million lines of code—that's approximately 16 kilometers of line printer output. This linear structure gives few clues as to how the overall system is organised, how individual modules are related to one another or how information flows between modules. In other words the distorting sequential arrangement of code effectively destroys the inherent architecture of a system.

Such software systems are very difficult to understand and change, they lack appropriate spatial organisation and visual clues that could indicate how components are related and interact. This lack of spatial separation among components sharply increases the complexity of software and makes it hard to understand. To make matters worse, the lack of separation of components and data greatly increases the chances of unintended side-effects and hence problems of reliability, security and failure.

Due to the complexity of modern software programs, efforts have been made to simplify the program development process. One approach is described in U.S. Pat. No. 4,734,854, assigned to American Telegraph and Telephone Company. The AT&T system allows commonly used software components to be designed and developed only once, and reused many times in different operational contexts and different requirements. The system includes a language for the specification of software components in a context-independent generic fashion, a compiler for the specification language and a program for generating concrete software components to work in a specific context.

The AT&T system allows reuse of software components, but it does not address the fundamental difficulty in design and programming of complex software systems. The system is text based and requires a detailed understanding of the specification language before advantages can be achieved. It is impossible to visualise the function of the software.

The software systems of the last forty years, including the AT&T system, have created a complexity barrier that prevents people from effectively exploiting their visual and spatial abilities (which are very highly developed in humans) in the design, representation and maintenance of computer-based systems.

A number of software providers have developed component technologies that provide fundamental integration services to high-level component frameworks. The available products include; COM, DCOM and ActiveX from Microsoft; SOM and DSOM from IBM; Java, JavaBeans and EJB from Sun Microsystems; and CORBA and OMA from Open Management Group, These component infrastructures are predominantly based around method and remote method invocation (RMI) standards at the coding level. They provide low-level support for direct inter-component communication and integration at the language or operating system level.

A major problem with RMI is the level at which components must be addressed and used. Because the integration is performed at a code-based level, components (or objects) tend to be fine-grained, addressing small operations or tasks rather than delivering large units of composition. The line or separation between components and code also tends to blur, as programmers build structures to support the component, hence affecting reusability. This blurring can be accredited in part to the fine-grained nature of the objects, as they do not represent significant units of composition. Furthermore, they do not support visual development or represent the initial high-level design.

### OBJECT OF THE INVENTION

It is an object of the present invention to provide a software design and programming system that preserves visualisation and data flow of the function of the software program.

Further objects will be evident from the following description.

### DISCLOSURE OF THE INVENTION

In one form, although it need not be the only or indeed the broadest form, the invention resides in a system for generating executable software comprising:

reusable components defining discrete software modules;

programmable channels defining data flows and control flows between components;

a visual environment supporting integration of the reusable components and programmable channels to display a visual representation of functional computer software; and

compiling means to convert the visual representation of the functional computer software to executable code.

The system may suitably be considered as a visual architecture software language.

The visual environment is preferably a graphical user interface.

The visual representation of the functional computer software in the visual environment corresponds to a visualisation of the function of the computer software.

The reusable components may reside and execute on a local computer or may be distributed over a computer network in a platform-independent manner.

The channels may be broadcast channels or component-to-component channels. Each channel type, broadcast and component-to-component, is capable of supporting a number of memory buffering models.

The compiling means preferably converts the visual representation of functional computer software into a series of executable instructions and one or more tables of data.

The system for generating executable software may further comprise an integration server for scheduling execution of the components and managing flow of data and control between components.

The integration server schedules execution of components according to the executable instructions generated by the compiling means. Individual components receive input from the integration server, execute, then pass output back to the server for transmission to other components, as specified in the visual representation. The integration server is like an operating system for running the executable code generated by the compiling means.

In a further form the invention resides in a system for generating executable software programs from reusable components and programmable channels, said system comprising:

a graphical user interface means for arranging components and channels to form a visual representation of functional computer software;

compiling means for compiling the visual representation of the functional computer software to an executable file; and

means responsive to the compiler for storing and running the executable file.

A component may be written in any language on any computer platform and may define a number of inputs and outputs

The invention may further include conversion means for converting conventional software applications to components, said conversion means providing system level translation between the inputs and outputs of the conventional software application and the required visual architecture software language inputs and outputs.

In preference, the compiling means maintains a distinct separation between data integration requirements and sequence control on one hand and the computational or functional specification on the other hand. The separation of functions is maintained throughout all stages of the development and delivery process, including but not limited to design, development, implementation and project management.

The computational aspects are isolated in the components. The data integration and sequence aspects are represented by the channels. By separating these aspects, the visual design constructed from the components and channels clearly represents the architectural structure of the application as a whole.

Preferably the means responsive to the compiler for storing and running the executable file incorporates an integration server capable of providing systems installation, data flow, data translation, data reordering, control flow, execution scheduling and network distribution between the reusable components of the visual representation of the functional software program.

In a yet further form, the invention resides in a method of generating an executable computer programme from reusable components and programmable channels, including the steps of:

representing functional computer software in a visual environment with the reusable components and the programmable channels to form a visual representation;

compiling the visual representation to generate executable code.

The step of compiling preferably converts the visual representation of the components and the channels into instructions for scheduling the execution of components and data for exchange between components.

Data flow between components and control flow between components is separated from and implemented differently to computational requirements in the visual architecture software language. Computational requirements are encapsulated and implemented in components. Unlike prior art languages, component integration is not a programming exercise, instead it reduces to an activity in which input/output relationships and interactions between components are specified graphically.

The responsibility of the programmer ends with the visual representation of interactions between visually represented components. The components that make up the system can be written in any language and can execute on different platforms.

### BRIEF DETAILS OF THE DRAWINGS

To assist in understanding the invention preferred embodiments will now be described with reference to the following figures in which

FIG. 1 shows a basic component symbols a pipe symbol to aid in describing the invention;

FIG. 2 shows an example problem;

FIG. 3 shows a representation of the problem of FIG. 2 using part of the invention;

FIG. 4 shows components and packs of components;

FIG. 5 shows channels;

FIG. 6 shows types of inputs;

FIG. 7 shows types of outputs;

FIG. 8 shows a first example of integration;

FIG. 9 shows a second example of integration;

FIG. 10 shows a third example of integration;

FIG. 11 shows a fourth example of integration;

FIG. 12 shows a fifth example of integration;

FIG. 13 is a visual depiction of a model railway system;

FIG. 14 is a VASL depiction of the model railway system;

FIG. 15 shows a train component;

FIG. 16 shows a station component;

FIG. 17 shows the model railway of FIG. 2 operating;

FIG. 18 is a snap shot of the visual design environment;

FIG. 19 shows a component information screen;

FIG. 20 represents the implementation of conversion means

FIG. 21 represents a further implementation of a conversion means;

FIG. 22 provides an overview of the build, design and run services of VASL; and

FIG. 23 shows an example of the additional information associated with a component.

### DETAILED DESCRIPTION OF THE DRAWINGS

In the drawings, like reference numerals refer to like parts. In order to explain the invention, it is necessary to summarise the symbols to be used in the following description.

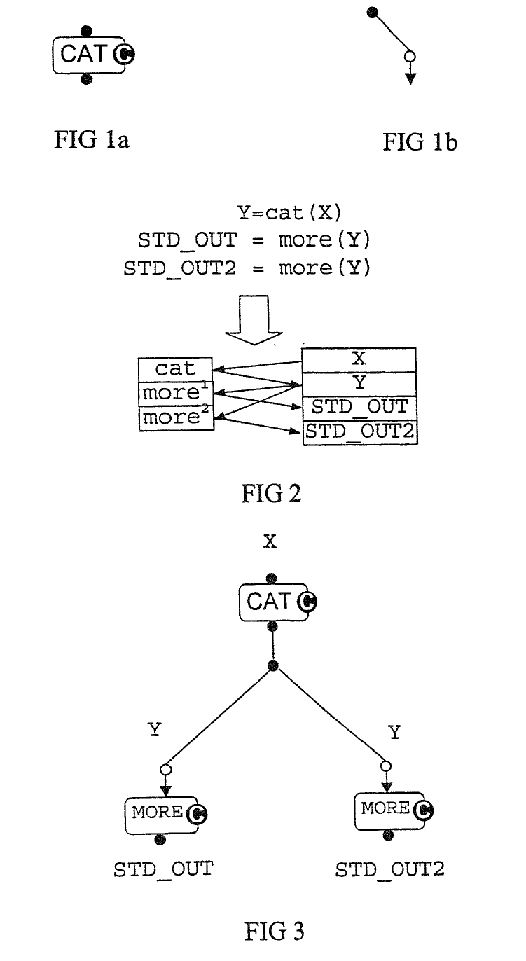

There are two fundamental building elements, shown in FIG. 1, used to implement the invention. The first is the component, this is represented as a rectangular box with inputs running along the top and outputs along the bottom and is shown in FIG. 1a. The second symbol is a channel, this represents the integration between components, the direction of data flow and the type of data being transferred and is shown in FIG. 1b.

Using these two symbols it is possible, for example, to visually represent a simple process that reads an input, X, and generates two outputs, STD_OUT and STD_OUT2. The process is represented in FIG. 2. The process, symbols and data flows can be represented by three components and four symbols, as shown in FIG. 3.

An advantage of the visual representation in FIG. 3 is the simplicity. The function or business abstraction is clearly visible. The order of execution and the flow of data is also obvious.

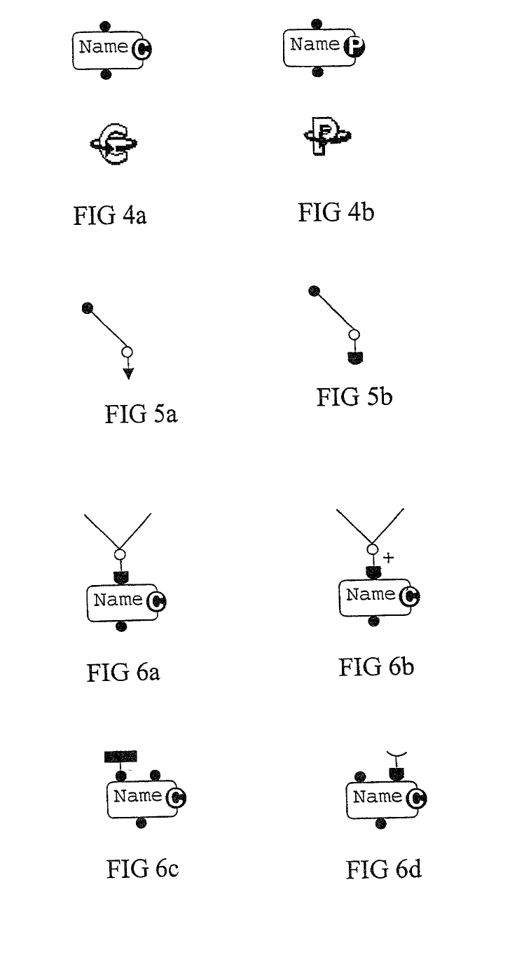

FIG. 4 shows the icons and graphics used to represent components (FIG. 4a) and packs of components (FIG. 4b). FIG. 5 shows the icons and graphics used to represent various forms of channels. The type of arrowhead at the end of a channel shows the direction of data flow and the type of data triggering being on (FIG. 5a) or off (FIG. 5b). The channels are therefore programmable to define both data flow and control flow.

There are three potential sources of input data shown in FIG. 6. Any number of channels can be connected to a single input. An ‘OR’ (FIG. 6a) or an ‘AND’ (FIG. 6b) relationship can be applied to multiple input channels. If no inputs have been connected then a constant value can be set for the component's input value as shown in FIG. 6c. The constant's value is set at design time, its value will always be returned to the component as the current data value. Similarly, inputs can receive a broadcast event a shown in FIG. 6d.

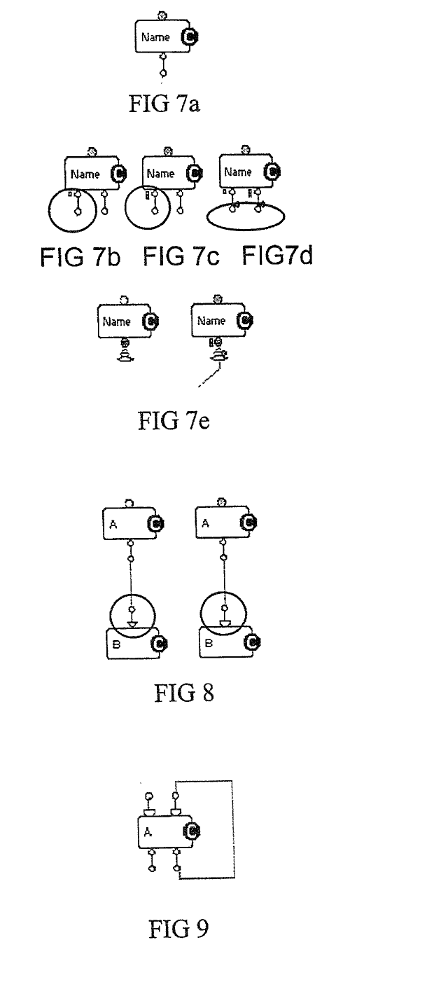

Symbols for standard component output are shown in FIG. 7a. Data can be directed to any number of downstream components such as a shared output shown in FIG. 7b, a unique output shown in FIG. 7c or a priority output shown in FIG. 7d. Outputs may also beas broadcast in the form of an event as shown in FIG. 7e. It is the component output point that specifies the type of memory buffering and priority to be used by the data stream.

The introduction of memory buffering and combined input sources significantly increases the scope and complexity of integration problems. The following five examples indicate the operation of the invention.

### EXAMPLE 1

FIG. 8 shows the simplest of the five integration examples. Output from A is sent directly to B.

If Data triggering is selected then component B will start as soon as the data stream begins, only one input source needs to be set as a ‘data trigger’ in order to start the downstream component. Alternatively, in the second system component B will not begin executing until component A terminates, as data triggering is switched off.

### Example 2

A natural extension of example 1 is the feed back loop shown in FIG. 9. Component A may use its own transformed data for further processing or for possibly recursive transformations. Although this may seem obvious it is not always a supported behavior in many integration models.

### Example 3

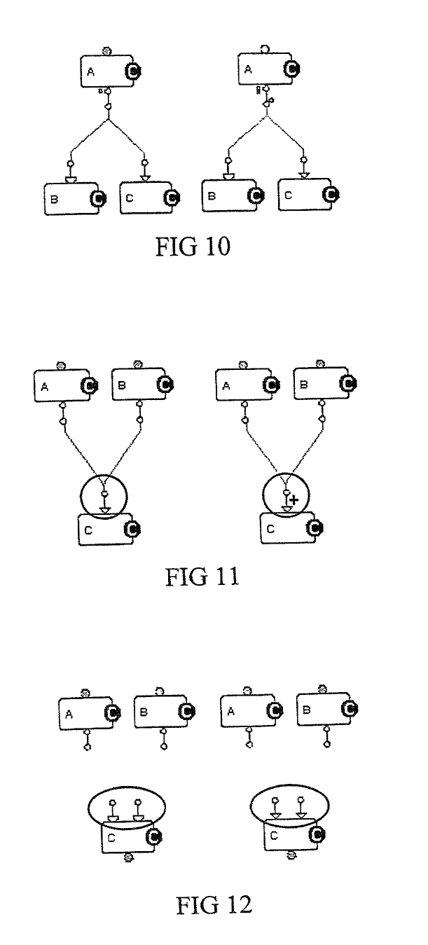

FIG. 10 displays the effect of memory buffering on the data flow. Components B and C may be sharing data directly or the data may be stored in a memory buffer. The buffer can be set up to hold a single item that is overwritten as new data becomes available. Alternatively, the buffer may be a shared buffer that holds a collection of items for use by all downstream components. Finally, the buffer may be unique and independent for each downstream component. The type of buffering employed affects the behavior of the process.

### Example 4

Two components may send data to a single downstream component, C, as shown in FIG. 11. Two possibilities, an ‘OR’ or an ‘AND’ relationship, are shown. If an ‘OR’ relationship is in use then input from either component A or B will trigger C. However, if an ‘AND’ condition is in place then input must come from both upstream components. This characteristic is particularly useful when trying to synchronize data streams or when confirmation is needed that a data buffer is available.

In the scenario where a single downstream component receives two or more input channels, it is possible to turn data priority on for any or all of the data sources. Data priority will ensure that the currently active input channel's buffer is emptied or exhausted by the downstream component before it relinquishes control to an alternative input source. This allows uninterrupted processing of any given data source.

### Example 5

In the example shown in FIG. 12, component C accepts input from two upstream components. Unlike the previous example each input arrives at a different destination or component input point. Each input is handled independently by the downstream component.

Again there are two possible behaviors. Firstly, if a relationship exists between the two input data sources then the component will need to turn data triggering ‘off’ in order to ensure that data is available from both upstream sources before it begins executing. Alternatively, if data triggering is ‘on’ then the downstream component is free to read and act on either upstream data source independently, triggering or starting execution on the first available source.

It will be noted that although these five examples represent quite different functionality or behavior they are still easily understood, even with a simple visual notation. This is not always the case when expressing subtle differences in more traditional code-based environments. This ability to visually express a wide range of behaviors without loosing detail or focus is one of the main benefits of using a visual design notation to express high-level design, structure and business abstraction.

### Implementation

A preferred embodiment of the invention will now be described in terms of an indicative implementation. The described implementation is for the purposes of description only and is not meant to be limiting in relation to the particular application or the language used.

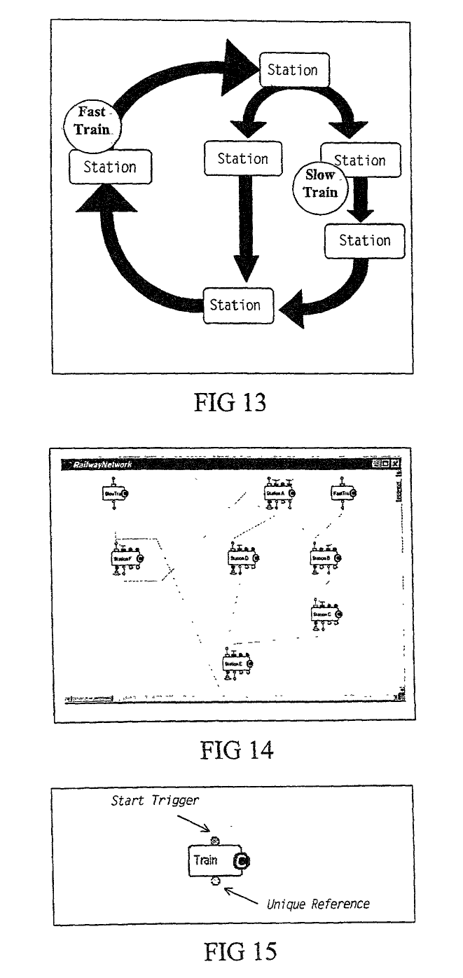

A suitable application for putting the invention in perspective is to build and implement a model railway. In the simplest form, a model railway consists of a network of tracks and stations on which various types of trains and vehicles can travel. The overall scheme of the model railway is shown in FIG. 13. It consists of 6 stations, a network of tracks and two trains. For the purposes of illustration, a number of limitations are placed on the railway system:

Trains should not collide;

A station can only accept one train at a time;

A station provides a maximum of three outgoing tracks;

There is no scheduling or pre-defined destination, the station chooses the next outgoing track randomly;

When a train arrives at a station it will exchange information, including the train and station names as well as the train's fuel status. If the train is running low of fuel then the station will trigger a refuel event;

Stations can be flagged as out of order, in which case no trains may use that station.

The VASL representation of the model railway is shown in FIG. 14. The stations and trains are represented as components and the tracks are represented as channels between the components. It can be seen that the SLOW TRAIN will start from STATION F and leave STATION F on line 1 to STATION A. After a random delay the train will leave STATION A on either line 1 or 3, which are selected randomly. The train will eventually travel to STATION E via STATION B and STATION C, or STATION D, and so on around the track.

The representation of the train component is shown in FIG. 15. The train component has a single input which is a START TRIGGER and a single output which is the UNIQUE REFERENCE of the train. The movement of the train around the model railway is represented by the passing of the unique reference from station to station.

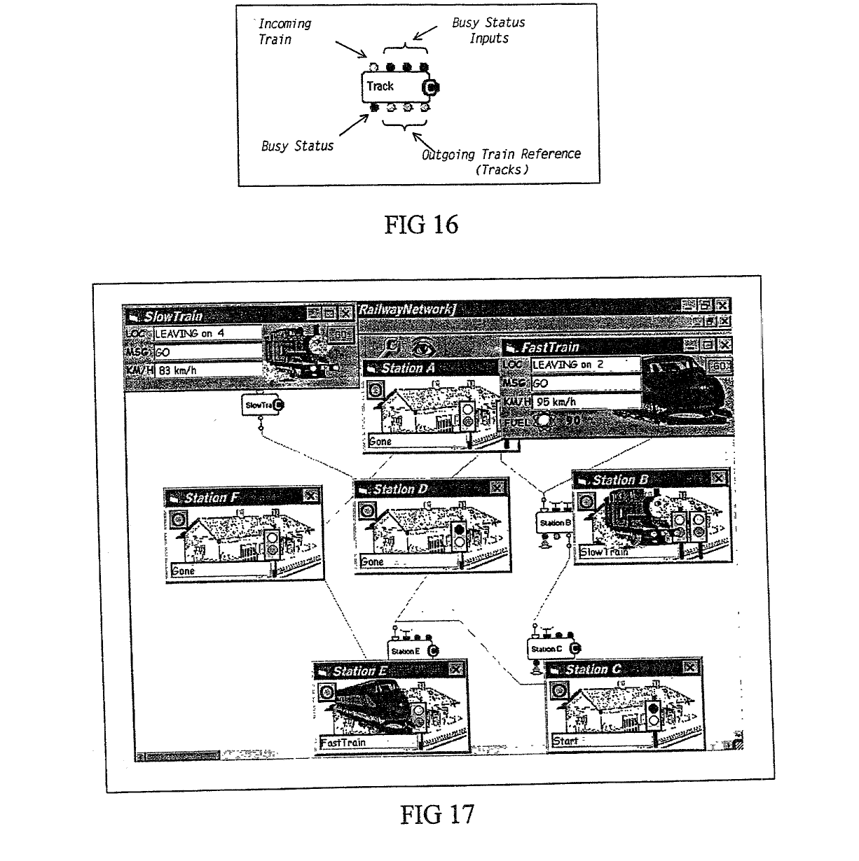

FIG. 16 shows a representation of the station component. The station component is more complex than the train component. The station component has four inputs, an INCOMING TRAIN input and three BUSY STATUS inputs. It has four outputs, a BUSY STATUS output and three OUTGOING TRAIN REFERENCE outputs.

The operation of the inputs and outputs is evident from FIG. 14. The TRAIN REFERENCE is passed between components from one of the OUTGOING TRAIN REFERENCE outputs to the INCOMING TRAIN input. Each OUTGOING TRAIN REFERENCE output has a corresponding BUSY STATUS input that watches for broadcast BUSY STATUS signals from the other station components. The BUSY STATUS inputs correspond to the active OUTGOING TRAIN REFERENCE outputs. The BUSY STATUS inputs and outputs are required to prevent a train reference being passed to a station that already has a train.

For example, STATION A has active BUSY STATUS inputs corresponding to the first and third OUTGOING TRAIN REFERENCE outputs. If STATION A detects a broadcast BUSY SIGNAL from STATION D it will not pass a train on the first OUTGOING TRAIN REFERENCE output until a NOTBUSY signal is detected.

It will be noted that all Station components have the same functionality and the functionality is defined by the inputs and outputs. The actual underlying code that implements the component is irrelevant to the invention. The only unique aspect of each component is the name and the channels. This allows for component reusability and means that the operation of the overall system is clearly visible from the graphical representation. Furthermore, the final working system is reflected in the initial visual design. This makes it particularly easy to add extra trains, stations or tracks, or to change the functionality of the components or channels.

An actual screen shot of the model railway system implemented in Visual Basic on a Windows 95 operating system is shown in FIG. 17. The OUTGOING TRAIN REFERENCE outputs for each station are depicted visually as traffic lights. Visual representation of unused outputs are suppressed. The BUSY STATUS output is shown as a message indicating which train is at a station or if a train has gone. The train components indicate their current status.

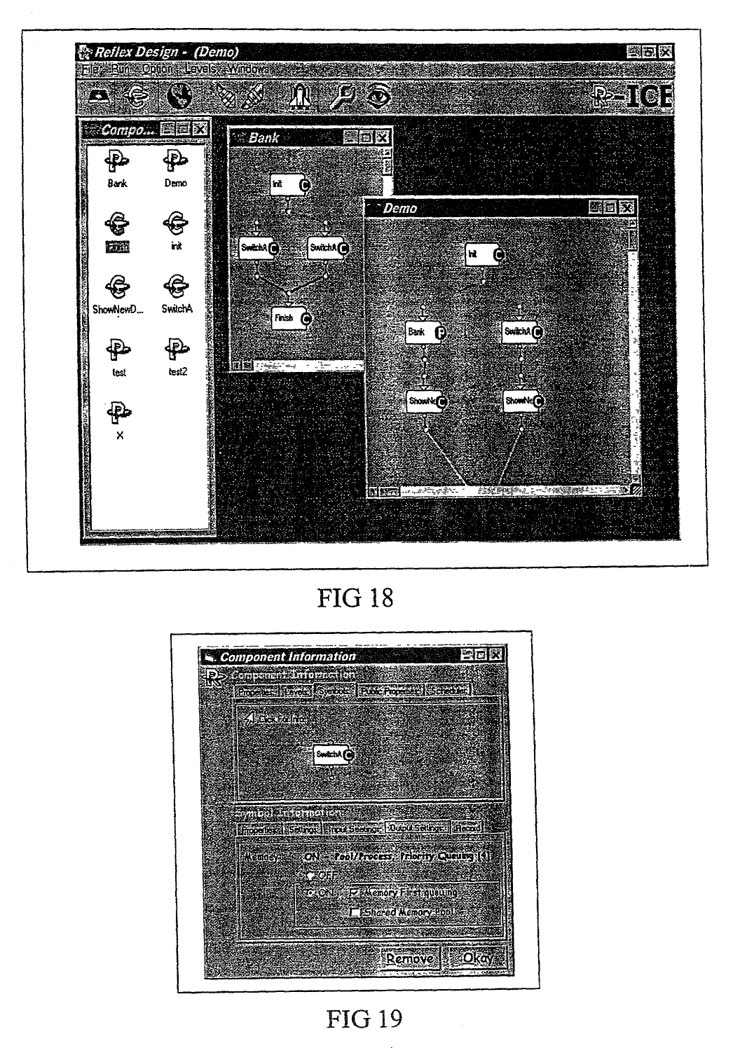

Individual components, depending on their size and complexity, may be constructed using conventional programming languages, and then compiled, and turned into a visual component representation with a well-defined external interface consisting of a set of inputs and outputs. They may also, if they are at a low enough level, be constructed from simpler visual components. The options are depicted in FIG. 18.

In FIG. 18 there is shown a Visual Design Environment to support VASL. The environment is implemented around a windows-based point and click interface for convenience, although other graphical interface will suffice. The environment can be divided into three distinct zones. At the top of the screen is the familiar toolbar that provides the user with easy access to all the main system functions. On the left is the Component Selection Window.

Two types of Components are shown in the Component Selection Window. The items showing a large letter ‘C’ are Components written in any language implemented for the operating system. The items showing a large letter ‘P’ are Packs of Components made up from a number of Components and channels.

The structure of the Bank Pack and the Demo Pack are shown in the Design Window. The Design Window is where the high-level systems are built from lower level components. The properties of any component can be accessed from a component information screen. An example Component Information Screen is shown in FIG. 19. The screen presents a single interface to all configurable component options, including:

Component properties;

Input and output memory and triggering options;

Shared symbol naming options;

Public interface information;

Component scheduling options.

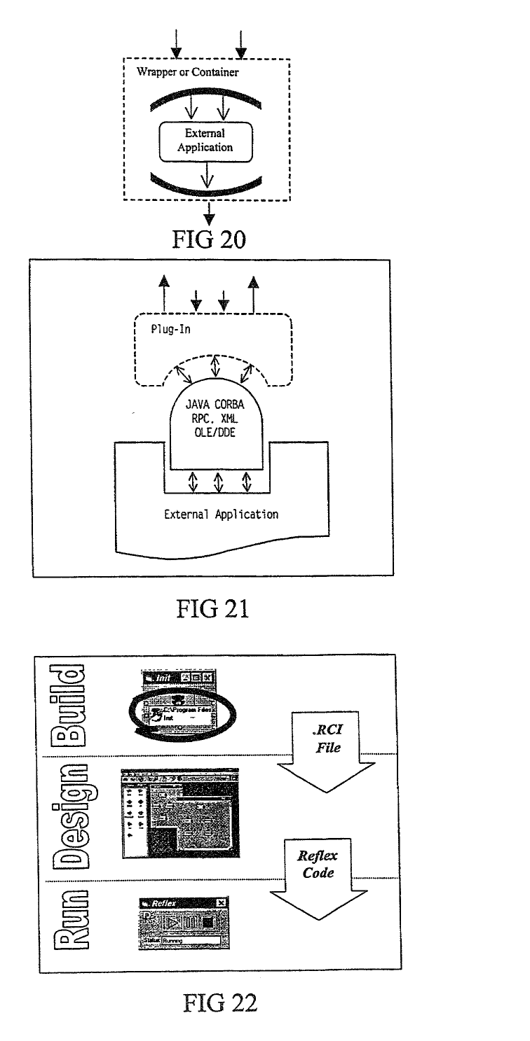

The above discussion has focussed on applications in a Windows environment. However, the invention is not limited to this environment. Furthermore, the above examples have shown component implementations in Visual Basic but the language of the components is not a limitation for the invention. FIG. 20 indicates one manner in which this can be implemented. Most programs accept some form of input at startup and produce some form of final output. An interface or ‘wrapper’ can form most external applications into a component useful in the invention. However, the wrapper does not change the functionality of the external application. The external application can only be useful if it has the required inputs and outputs.

External applications that use modern programming technologies, such as Enterprise Java Beans (EJB) and Corba, can be adapted for use in the invention as plug-ins and wrappers or containers. This approach to component integration is depicted in FIG. 20 and FIG. 21.

In order to fully implement the invention, three stages are supported. These are building components and component packs, designing course-grained applications from the components and running the programmes. These stages are depicted in FIG. 22.

Running the software program is simple once the high-level design is completed. All design checks are carried out prior to execution, these checks include:

Correct initialisation and termination states;

That all mandatory inputs are provided;

Packs are incorporated correctly;

Data type matching between outputs and inputs;

Record types are checked to make sure they are compatible.

The invention can automatically generate code from the high-level design. The code is passed to the integration server run-time services for execution.

The visual architecture software language provides a number of advantages over conventional text-based software. Firstly, the system design remains visible rather than being distorted by the linear textual approach. Complexity is reduced and readability enhanced. Maintenance is much simpler because errors can be isolated in individual components or channels.

Because components are self-contained there is no necessity to understand how a given component works. All that is required is a knowledge of the inputs and outputs. Suitable components can therefore be selected from a library of components to build into a system. This feature also means that components can be upgraded without consequent modification to linked components.

Significant reductions in coding size, complexity, interrelationships and integration concerns are realised by maintaining the separation of the functional/computational aspects of the system from the data/integration aspects. By providing a data focus the invention simplifies the individual component design process, allows building of isolated and reusable components which are significantly smaller and easier to write, and increases the flexibility and architectural support of the system and its design tools.

Expansion of a software program is also simplified. A working system can be expanded by adding additional components and channels. In the model railway example, an extra train can be added by moving a train component to the Design Window and providing a channel to an available station.

The invention is useful for business modeling and project costing. Because each component equates directly to an actual business function, a statistical analysis of the running software gives information on the operation of the modeled business. The modeling can help to identify key business functions and potential problem areas.

The invention has been described in terms of core capabilities and a number of example applications. The delivered visual architecture software language will also incorporate other services including automated systems documentation, project and resource management, critical path management, statistical analysis of the system and automatic deployment management. These services are supported in the visual design environment, providing a graphical representation of development progress, milestones, resource use, costs, system completion and delivery estimation, critical path deployment and other such project management factors.

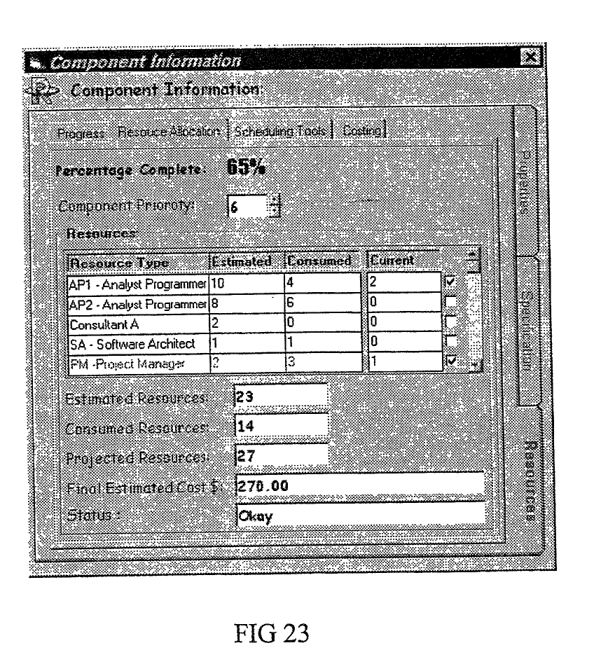

The invention can also provide for enhanced component information by providing a pop-up description window as shown in FIG. 23. The description may include details of the component's inputs and outputs, documentation (such as legal, user, help and management files), statistical data, costs, resource requirements, performance and development requirements. This feature allows the management of the component-based system at an individual component level, on a sub-set of all components, or a whole-of-system basis.

Furthermore, it becomes possible to test each component in isolation via its public interface. The public interface allows test cases to be written and executed automatically, allowing the component developer to implement, test and evolve components while guaranteeing correct results based on known test cases.

The visual architecture software language component interface standard also supports single, multiple and user definable public component interfaces. Under this interface arrangement a component may have multiple interfaces comprised of an arbitrary collection of the component's total inputs and outputs, based on possible functional requirements. Furthermore, the actual component user is able to arbitrarily build a new public interface for an existing component based on a subset of the new component's functionality. In addition, each component interface maintains descriptive information (both in text and in diagrammatic form) about the component, it's functions, it's interfaces and the various inputs and outputs used. All of these public interface aspects are available through the visual environment provided by the visual architecture software language.

Throughout the specification the aim has been to describe the preferred embodiments of the invention without limiting the invention to any one embodiment or specific collection of features.

1. A system for generating executable software comprising:
reusable components defining discrete software modules;
programmable channels defining data flows and control flows between components;
a visual environment supporting integration of the reusable components and programmable channels to display a visual representation of functional computer software; and
compiling means to convert the visual representation of THE functional computer software to executable code.

2. The system of claim 1 wherein the visual environment is a graphical user interface.

3. The system of claim 1 wherein the components are executable programmes.

4. The system of claim 1 wherein the components are written in any language on any computer platform.

5. The system of claim 1 wherein the components reside and execute on a local computer.

6. The system of claim 1 wherein the components are distributed over a computer network in a platform-independent manner.

7. The system of claim 1 wherein the components define one or more inputs and one or more outputs.

8. The system of claim 1 wherein the channels are broadcast channels or component-to-component channels.

9. The system of claim 1 wherein the channels support memory buffering.

10. The system of claim 1 wherein the compiling means converts the visual representation of functional computer software into a series of executable instructions and one or more tables of data.

11. The system of claim 1 further comprising conversion means for converting conventional software applications to components, said conversion means providing system level translation between the inputs and outputs of the conventional software application and the required visual architecture software language inputs and outputs.

12. The system of claim 1 further comprising an integration server for scheduling execution of the components and managing flow of data and control between components.

13. A system for generating and running executable software from reusable components and programmable channels, said system comprising:
a visual environment for arranging components and channels to form a visual representation of functional computer software;
compiling means for compiling the visual representation of the functional computer software to an executable file; and
means responsive to the compiler for storing and running the executable file.

14. The system of claim 13 wherein the visual environment is a graphical user interface.

15. The system of claim 13 wherein the means responsive to the compiler for storing and running the executable file incorporates an integration server capable of providing data flow, control flow, execution scheduling and network distribution between the reusable components of the visual representation of the functional software program

16. A method of generating an executable computer programme from reusable components and programmable channels, including the steps of:
representing functional computer software in a visual environment with the reusable components and the programmable channels to form a visual representation;
compiling the visual representation to generate executable code.
said executable code comprising

17. The method of claim 16 wherein the step of compiling converts the visual representation of the components and the channels into instructions for scheduling the execution of components and data for exchange between components.

18. A visual architecture software language comprising:
reusable components defining discrete software modules;
programmable channels defining data flows and control flows between components;
a visual environment supporting integration of the reusable components and programmable channels to display a visual representation of functional computer software; and
compiling means to convert the visual representation of functional computer software to executable code.
